(19) United States
(12) Patent Application Publication
(10) Pub. No.: US 2017/0235924 A1
(43) Pub. Date: Aug. 17, 2017

(54) System and Network for Controlling Content and Accessibility

(71) Applicant: Bank of America Corporation, Charlotte, NC (US)

(72) Inventors: William A. Kuehler, Sanatoga, PA (US); Prasanth Balasubramanian, Chennai (IN); Karthik Kongara, Monmouth Junction, NJ (US); Satyanarayana Yalla, Cranbury, NJ (US); Santosh Kokkirala, Monmouth Junction, NJ (US)

(21) Appl. No.: 15/045,632

(22) Filed: Feb. 17, 2016

(51) Int. Cl. G06F 21/10; H04L 29/06

(52) U.S. Cl. CPC G06F 21/10; H04L 63/102; G06F 2221/0737

(57) ABSTRACT

Systems and/or devices for controlling access to a content distribution system and/or controlling content distributed via the system are provided. In some examples, a system may include a content distribution computing platform that may be configured to receive credentials from a user, generate a user interface and transmit the user interface to the user. Via the generated user interface, a user may request to distribute content to one or more computing destinations, such as one or more folders, servers, or other computing destinations or devices. Upon receiving the request, the system may determine whether the user is authorized to distribute content, whether a type of content associated with the content is authorized for distribution and/or whether attributes of the content are permitted for distribution. If so, the content may be distributed. If not, a notification may be transmitted to the user (e.g., to a computing device of the user).

### BACKGROUND

Aspects of the disclosure relate to computer hardware and software. In particular, one or more aspects of the disclosure generally relate to computer hardware and software for controlling content distributed in a network share and accessibility for distributing the content.

Organizations, such as corporate entities and other large enterprise organizations, may often manage shared networks, file structures, and the like, to which hundreds, thousands, or more, users have access to distribute content. Providing access to such a large number of users without controlling access, types of files to be distributed, file attributes, and the like, can lead to security issues. Further, distributing content to multiple locations and/or controlling content for multiple locations can be time consuming and inefficient.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure relate to computer systems that provide effective, efficient, and convenient ways of controlling access to a content distribution system and/or controlling content distributed via the system. In some examples, a system may include a content distribution computing platform that may be configured to receive credentials from a user, generate a user interface and transmit the user interface to the user. Via the generated user interface, a user may request to distribute content to one or more computing destinations, such as one or more folders, servers, or other computing destinations or devices. Upon receiving the request, the system may determine whether the user is authorized to distribute content, whether a type of content associated with the content is authorized for distribution and/or whether attributes of the content are permitted for distribution. If so, the content may be distributed. If not, a notification may be transmitted to the user (e.g., to a computing device of the user).

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an illustrative content distribution computing platform for controlling access to a content distribution system and/or controlling distribution of content according to one or more aspects described herein;

FIGS. 2A and 2B depict an illustrative event sequence for controlling content for distribution according to one or more aspects described herein;

FIG. 3 illustrates one example method of controlling content for distribution according to one or more aspects described herein;

FIG. 4 illustrates one example user interface for requesting distribution of content according to one or more aspects described herein;

FIG. 5 illustrates one example user interface providing a record of content distributed and/or various other modifications or edits according to one or more aspects described herein;

FIG. 6 illustrates one example user interface for providing functionality to an administrator of a content distribution system according to one or more aspects described herein;

FIG. 7 illustrates one example operating environment in which various aspects of the disclosure may be implemented in accordance with one or more aspects described herein; and

FIG. 8 depicts an illustrative block diagram of workstations and servers that may be used to implement the processes and functions of certain aspects of the present disclosure in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As discussed herein, large corporations, universities, government agencies, and the like, often have systems that permit a plurality of users to distribute content (e.g., files) to one or more destinations, such as a plurality of servers, folders within a file structure, and the like. However, controlling access to the system, as well as the type of content being distributed, can be inefficient, time consuming, and prone to errors. Accordingly, a system for controlling access to distribute content, as well as controlling the content being distributed is described herein. The system may generate and provide a user interface through which a user may request to distribute content to one or more computing destinations (e.g., servers, folders, and the like). The system may determine whether a user is authorized to distribute content to a particular location, control the type or attributes of content being distributed, and the like. In some examples, control may be performed at a granular level. For instance, a file structure may have different settings or parameters for permitting users to distribute content, type of content, and the like, for each individual user, role of a user, level within a file structure, folder, or the like. Accordingly, the system provides a convenient interface to control aspects of content distribution which would otherwise be cumbersome and error-prone.

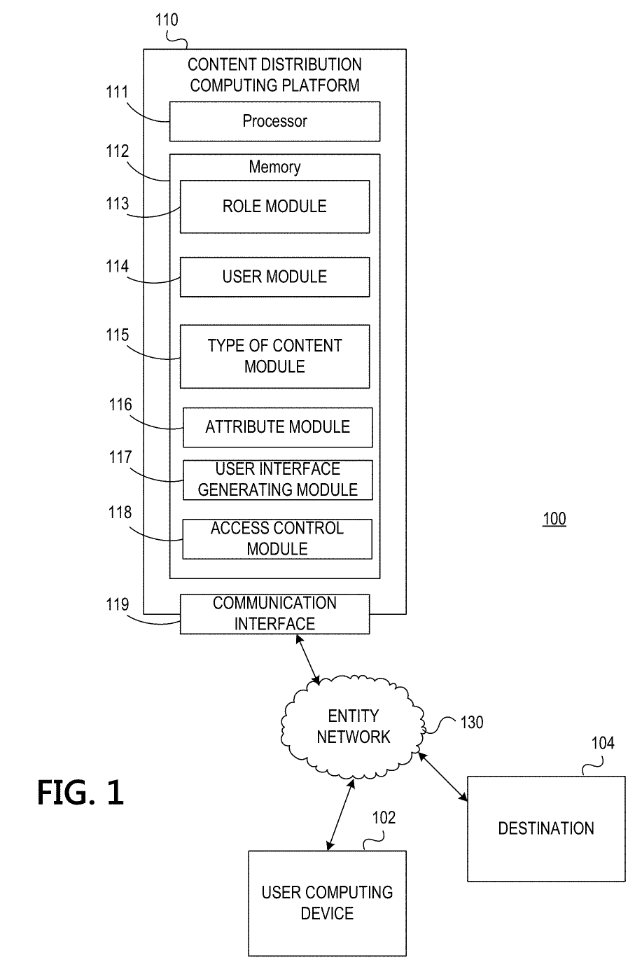

FIG. 1 depicts an environment 100 including an illustrative computing platform for distributing content, according to one or more aspects described herein. For instance, the environment 100 includes a content distribution computing platform 110, which may include one or more processors 111, memory 112, and communication interface 119. A data bus may interconnect processor(s) 111, memory 112, and communication interface 119. Communication interface 119 may be a network interface configured to support communication between content distribution computing platform 110 and one or more networks (e.g., network 130). One or more computing destinations 104 may be in communication with the content distribution computing platform 110 (e.g., via network 130). Memory 112 may include one or more program modules having instructions that when executed by processor(s) 111 cause content distribution computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of content distribution computing platform 110 and/or by different computer systems that may form and/or otherwise make up the content distribution computing platform 110. In some arrangements, different features or processes performed may be performed by different sets of instructions, such that the processor may execute each desired set of instructions to perform different functions described herein.

For example, memory 112 may include a role module 113. The role module 113 may include hardware and/or software configured to perform various functions within the content distribution computing platform. For instance, the role module 113 may generate and/or store (e.g., in a database within the module) one or more roles associated with various users. For instance, a user may be assigned to one of two roles, a user role or an administrator role. In another example, a plurality of roles may be available and a user may be assigned one of the plurality of roles. Each role may have different permissions for distributing content. In some examples, a role of a user may be based on a variety of factors, such as job function, time employed by the entity, job or position level, and the like. Accordingly, changes may be made to permissions by role, as desired. That is, different roles may be permitted to distribute different types of content, content with different attributes, and the like.

The content distribution computing platform 110 may further include a user module 114. The user module 114 may include hardware and/or software configured to perform various functions within the content distribution computing platform 110. For instance, the user module 114 may determine and/or store user information, such as login information, as well as a role for each user. In some examples, permission to distribute content may be based on a user requesting to distribute content. Accordingly, the content distribution computing platform may access user information in the user module 114 to determine permissions associated with the user (e.g., whether the user is permitted to distribute content), a role of the user, and the like.

The content distribution computing platform 110 may further include type of content module 115. The type of content module 115 may include hardware and/or software configured to perform various functions within the content distribution computing platform 110. For instance, the type of content module 115 may store one or more types of content (e.g., types of files, and the like) and associated permissions. Accordingly, if a request to distribute content is received, the type of content module 115 may review the type of content for distribution to determine whether that type of content is permitted for distribution. In some examples, the permissions may be stored by user or role (e.g., one user or role may be able to distribute a first type of content while another user or role might not) or may be based solely on the type of content and permissions may be the same for that type of content regardless of the user or role.

In other examples, whether a type of content is permitted for distribution may be based on a destination of the content. That is, different permissions may exist for distributing content to different destinations. For example different folders may have different permissions for a type of content. In another example, different levels within a file structure may have different permissions. In still another example, different servers or types of servers may have different permissions for the type of content permitted.

The content distribution computing platform 110 may further include an attribute module 116. The attribute module 116 may include hardware and/or software configured to perform various functions within the content distribution computing platform 110. For instance, the attribute module 116 may store one or more attributes or types of attributes of content and associated permissions. In some arrangements, attributes such as documents that are read-only, editable, or the like, may have different permissions. Accordingly, when a request to distribute content is received, the attributes of the content are analyzed by the attribute module 116 and a determination may be made as to whether the attributes of the content are permitted for distribution, either by a particular user, a user in a particular role, to the requested destination, or in general.

The content distribution computing platform 110 may further include a user interface generating module 117. The user interface generating module 117 may include hardware and/or software configured to perform various functions within the content distribution computing platform 110. For instance, the user interface generating module 117 may be configured to generate one or more user interfaces configured to permit users to request content distribution, upload content for distribution and the like. The user interfaces may be displayed to a user via user computing device 102, which may be one of various types of computing devices (e.g., tablet computing device, laptop computing device, smartphone, cell phone, desktop computing device, and the like). The interfaces generated may be unique to a user, role of a user, or the like. In some examples, the user interface generating module 117 may generate user interfaces for system administrators that may have functionality in addition to or different from the functionality provided via user interfaces generated for a user or role other than an administrator. For instance, the administrator user interfaces may include functionality associated with establishing permissions for users, roles, types of content, attributes, and the like. Additionally or alternatively, the user interfaces generated for administrators may be configured to prevent access to the content distribution system for a particular user, group of users (e.g., a business unit within a entity), a role, or the like. Various other functionality may be provided in the generated users interfaces as will be discussed more fully herein.

The content distribution computing platform 110 may further include an access control module 118. The access control module 118 may include hardware and/or software configured to perform various functions within the content distribution computing platform 110. For instance, the access control module 118 may be configured to permit an administrator or other administrative level user to control permissions and/or activate or deactivate permissions. In some arrangements, a user (such as an administrator) may request (e.g., via one or more dynamically generated user interfaces) to permit a user, role, business group, or the like, to distribute content. Alternatively, the administrator may desire to prevent a user, role, business group, or the like from distributing content. The permissions may be indicated via the user interface and the access control module 118 may store the access and modify the stored access based on input received.

As indicated above, the system 100 may include one or more computing destinations 104. The computing destinations 104 may be devices that are physically separate from other devices within the system (e.g., content distribution computing platform 110, user computing device 102, or the like) or may be part of the same physical device. The computing destination 104 may include one or more servers, folders within a file structure, or the like. Content may be distributed to the computing destination 104 upon meeting any desired permissions, as described more fully herein.

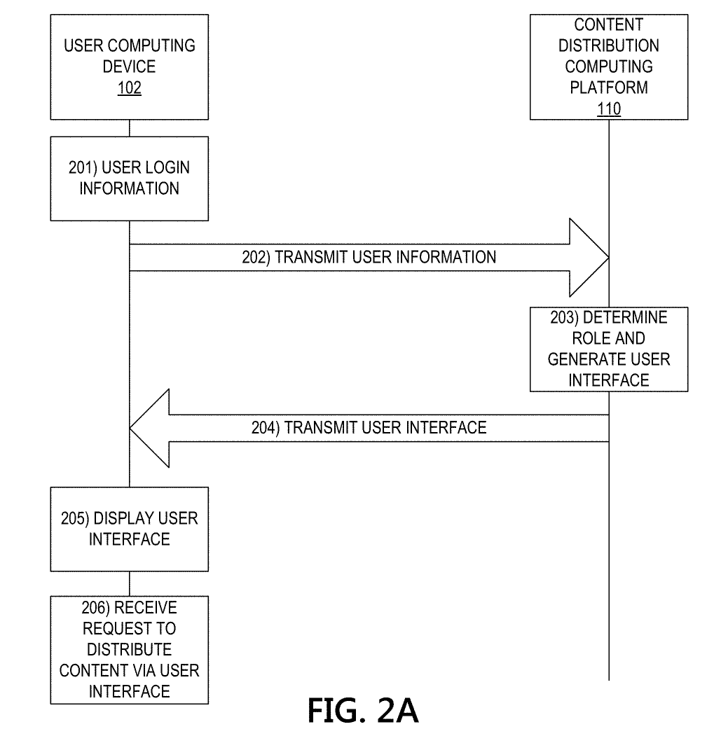

FIGS. 2A and 2B illustrate one example event sequence for distributing content via the content distribution systems and arrangements described herein. The sequence illustrated in FIGS. 2A and 2B is merely one example sequence and various other events may be included, or events shown may be omitted, without departing from the invention.

In step 201, user login information is received, e.g., by a user device 102. The user login information may include a unique identifier associated with the user, such as a username, employee number or other unique alphanumeric identifier, as well as a password, personal identification number (PIN), or the like. The login information may be transmitted to, for instance, the content distribution computing platform 110 in step 202.

In step 203, a role of the user may be determined (e.g., by the role module 113 and based on the login information of the user). A user interface may then be dynamically generated. The user interface may be unique to, or provide functionality unique to, the determined role, the user, or the like. The generated user interface may be transmitted to the user device 102 in step 240.

In step 205 the generated user interface may be displayed and, in step 206, a request to distribute content may be received via the user interface. The request to distribute content may be received via the user interface and may include uploading the content, selecting content from a file or other storage location, or the like. The request to distribute the content may include one or more destinations of the content. For instance, example destinations may include various files or folders within a file structure, a plurality of different server devices, or the like.

In step 207, the request to distribute content may be transmitted from the user computing device 102 to the content distribution computing platform 110. In step 208, a determination may be made as to whether the user (e.g., based on login information, role information, or the like) is authorized to distribute content. If not, a notification may be transmitted to the user computing device 102 indicating that the user is not authorized. If so, a determination may be made in step 209 as to whether a type of content of the content being distributed is permitted. If not, a notification may be transmitted to the user computing device 102 indicating that the type of content is not permitted.

In step 210, a determination may be made as to whether attributes of the content are permitted. If not, a notification may be transmitted to the user computing device 102 indicating that the attributes are not permitted. If so, the content may be distributed in step 211 (e.g., to one or more computing destinations 104). In some examples, distributing the content may include replicating the content (e.g., file) to the identified or requested one or more computing destinations.

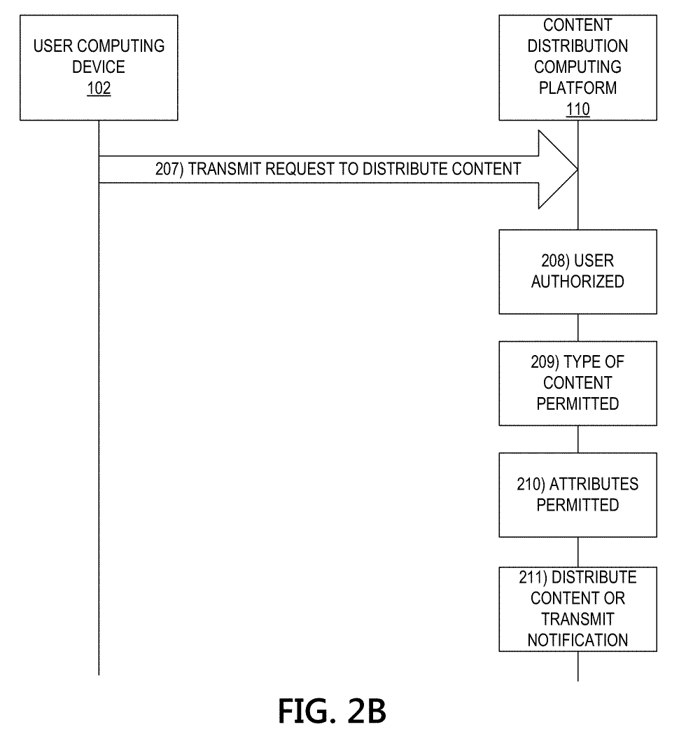

FIG. 3 illustrates one example method of distributing content according to one or more aspects described herein. In some examples, content for distribution may be received by the system in step 300. The content may include files of various types, having various attributes, and the like. In some examples, distribution may be to one or more folders, one or more different servers, and the like. The content received for distribution may also include an indication of the destination to which the content will be distributed.

In step 302, the system may determine whether the user accessing the system is authorized to distribute content via the system and/or is authorized to distribute content to the particular destination(s) received in step 300. For instance, the system may compare a user's credentials (e.g., login credentials, authentication information, biometric data, or the like) to pre-stored access information (e.g., stored in one or more databases). Upon determining that the user is authorized to access the system, the system may determine whether the destination location selected by the user (e.g., received in step 300) is associated with the user. For instance, the system may determine whether the destination location(s) match one or more pre-stored destinations to which the user may distribute content (e.g., stored in one or more databases).

If, in step 302, the user does not have access to the system and/or is not authorized to distribute content to the selected destination, a notification may be transmitted to the user in step 310 and the process may end. Alternatively, if the user does have access to the system and is authorized to distribute content to the selected destination(s), the process may proceed to step 304 in which a determination is made as to whether the type of content can be distributed. For instance, in some examples, a type of content permitted for distribution to one or more computing destinations may be restricted. For instance, a type of file to be distributed may be restricted to certain types of files (e.g., PDF, XLS, DOC, or the like).

If, in step 304, the type of content being distributed is not a permitted type, a notification may be transmitted to the user in step 310 and the process may end. Alternatively, if the type of content is permitted, the process may continue to step 306 in which a determination is made as to whether attributes of the content are permitted. For instance, the system may determine whether the attributes of the content to be distributed meet any restrictions. In one example, a file may be distributed if it is an editable version of the file. If the file is not editable, distribution might not be permitted.

Accordingly, if attributes of the file do not meet the parameters for the selected destination location(s), a notification may be transmitted to the user in step 310 and the process may end. Alternatively, if the attributes do meet the parameters, the content may be distributed in step 308. Distribution of the content may include replicating the content to one or more destination servers, folders, file structures, or the like.

In some examples, one or more steps of the process may be performed by the processor executing at least one set of instructions. In some arrangements, different functions within the process may be associated with different instructions executed by the processor (e.g., a first set of instructions, a second set of instructions, and the like).

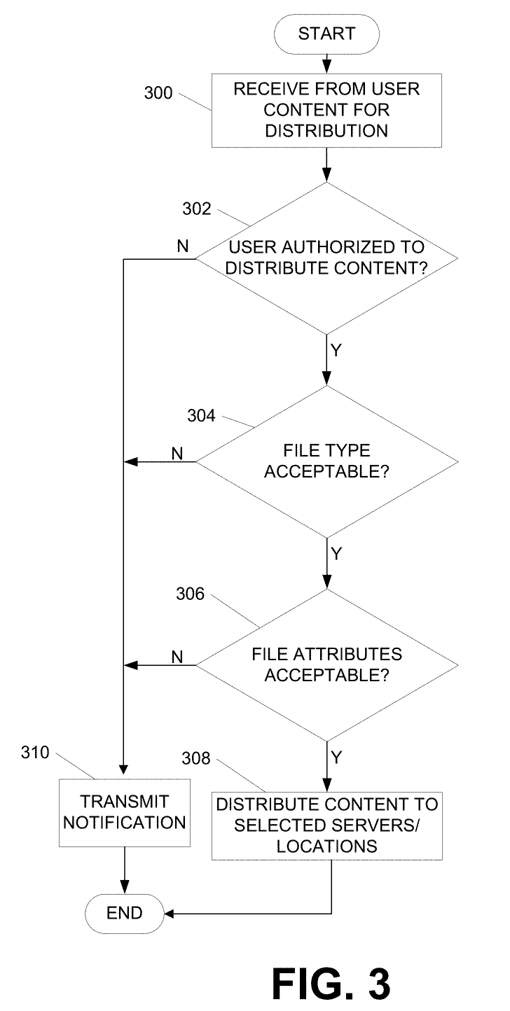

FIGS. 4-6 illustrate various user interfaces that may be dynamically generated by the content distribution computing platform 110 (e.g., by the user interface generating module 117). The interfaces are merely some example interfaces and various other interfaces with more or less functionality may be generated without departing from the invention.

FIG. 4 illustrates one example user interface 400 that may be dynamically generated for a person having a first role (e.g., “Role 1” on tab 402). The interface 400 may include a plurality of tabs (e.g., tabs 404, 406, 408, 410) that may be selectable. In some examples, tabs that are not available for selection may be grayed out, such as tabs 406, 408 and 410.

As discussed herein, various roles may be assigned to users, groups, and the like.

Accordingly, the user interface generated for a particular user or role may be different from or include functionality different from an interface generated for other users or roles. For instance, interface 400 includes tabs for various different roles, such as Role 1 402, Role 2 406, Role 3 408 and Administrator 410. More or fewer roles may be generated or assigned without departing from the invention. Each role may have a different user interface or an interface with different functionality.

Interface 400 illustrates functionality provided to a user or group assigned to Role 1 402. Accordingly, a user may select to upload a file by selecting option 412, select a destination for content distribution by selecting option 414, and/or create a directory by selecting option 416.

Selection of any of those options may prompt one or more additional interfaces requesting additional information. Additionally or alternatively, interface 400 may be modified upon selecting one of the options to request information, such as destination, and the like.

Interface 400 may further include history section 418. Section 418 may include a listing of content previous distributed by a user in Role 1. Information provided may include file name, path, permissions associated with that file, and/or a date modified or the like. Additional information may be provided in section 418 without departing from the invention.

Although the tabs provided in interface 400 are generally identified by role, in some arrangements, the tabs may be identified by user, business unit, or the like. Accordingly, a user interface specific to the user, business unit, or the like would be generated and provided, rather than a user interface particular to the role.

A user may process any changes made by selecting “OK” option 422. Alternatively, a user may cancel and input provided or modifications made by selecting “CANCEL” option 420.

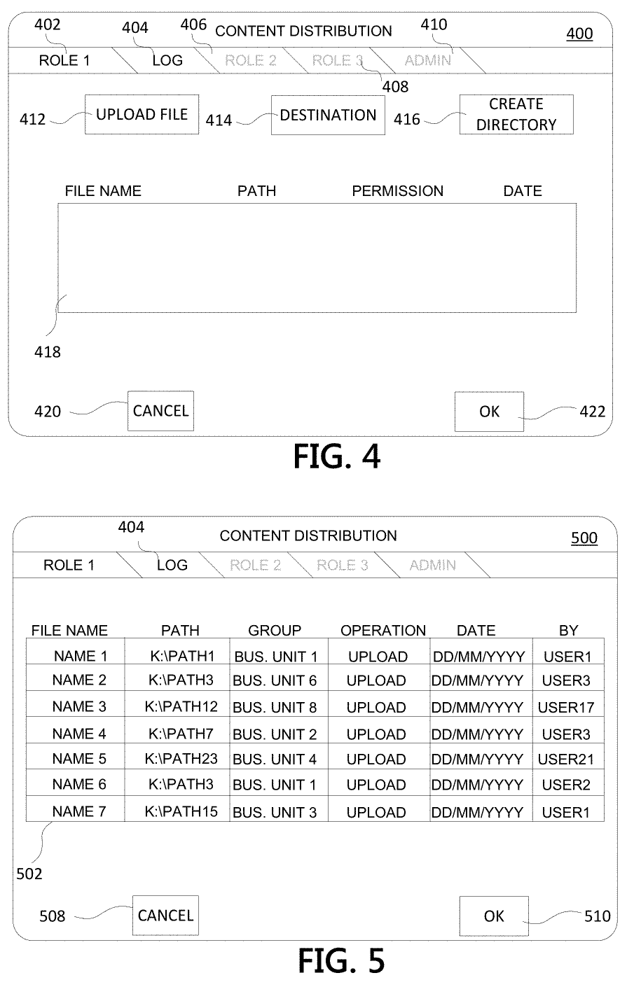

Interface 400 may further include a “log” tab 404. The log 404 may be a record of changes made (e.g., by a plurality of users, roles, business units, or the like). FIG. 5 illustrates one example user interface illustrating an example log 500. The log 500 shown in FIG. 5 may be displayed upon selection of log tab 404 and may represent a record of content distributed by users in role 1, by all users, by users in another role, or the like.

Interface 500 may include section 502 in which records of content distributed may be provided. Section 502 includes identification of a file distributed, the path or destination to which is was distributed, a group associated with the distribution, a type of distribution, a date of modification or date on which distribution occurred, and a user associated with distribution of the content. Additional information may also be provided. In some examples, selection of a file from the list provided in section 502 may prompt display of an additional user interface that may provide additional details, such as permissions associated with the file, attributes of the file, type of content, and the like.

The log, such as the log shown in interface 500, may provide an efficient device for conducting audits of the system, understanding timing of one or more distributions or modifications, identifying potential sources of issues, and the like.

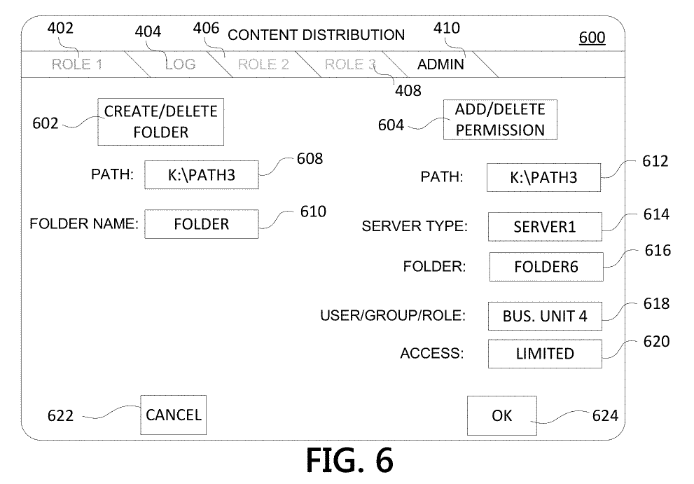

FIG. 6 illustrates one example user interface 600 that may be generated for an administrator. Administrator tab 410 is shown as selected in interface 600 and functionality provided to an administrator is provided via the user interface. In some examples, some or all of the functionality provided via interface 600 might not be available to users in non-administrator roles.

In some examples, an administrator may have the ability to create or delete a folder, such as a folder within a file structure, by selecting option 602. In some examples selection of option 602 may prompt display of fields 608 and 610 in which a path or destination and folder name, respectively, may be identified. In other arrangements, interface 600 may display fields 608 and 610 and selection of create or delete folder option 602 may cause the system to process information provided in those fields (e.g., a desired folder, path, destination, or the like, for creation or deletion).

In another example, interface 600 may include an option to modify permissions. For instance, add/delete permissions option 604 may be selected to modify permissions associated with various aspects of the system, such as group, role or user overall permissions, destination permissions, folder permissions, content attribute permissions, and the like. A user may provide information such as a path or destination in field 612, server type in field 614, folder name in field 616, user, group or role being modified in field 618, and/or access type in field 620. More or fewer options may be provided to a user as desired.

Accordingly, an administrative user may easily, via the generated user interface 600, modify permissions associated with the system (e.g., for different users, business units, roles, and the like). This may provide an efficient means of controlling distribution of content. That is, in an emergency situation, an administrative user may control access to the content distribution system and, in some examples, may prevent some or all users from distributing content (e.g., potentially malicious content in an emergency situation) via the interface 600 without requiring multiple steps to identify different destinations, modify permissions for each destination, and the like.

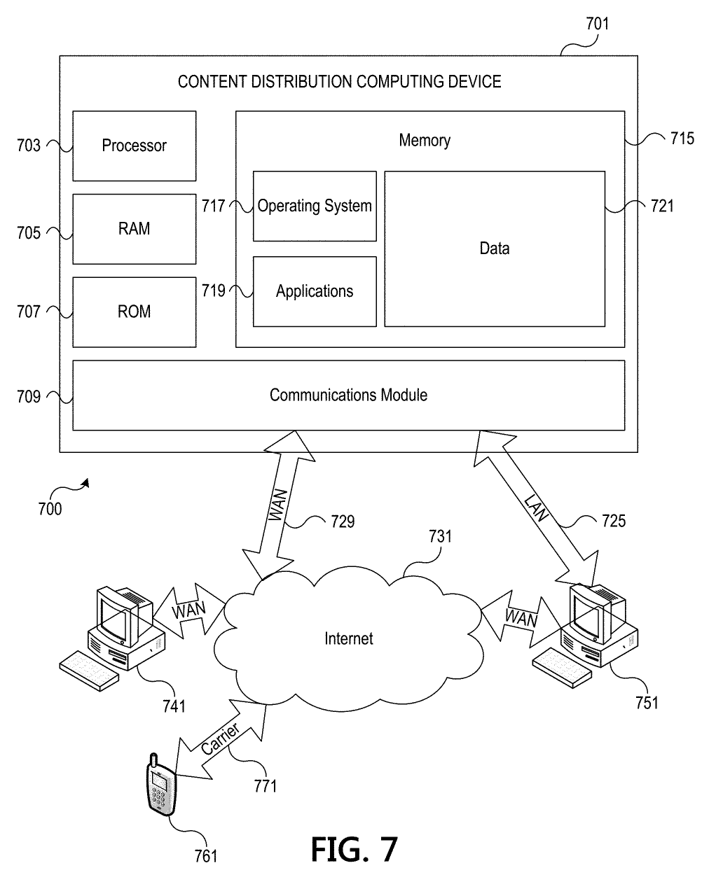

FIG. 7 depicts an illustrative operating environment in which various aspects of the present disclosure may be implemented in accordance with one or more example embodiments. Referring to FIG. 7, computing system environment 700 may be used according to one or more illustrative embodiments. Computing system environment 700 is only one example of a suitable computing environment and is not intended to suggest any limitation as to the scope of use or functionality contained in the disclosure. Computing system environment 700 should not be interpreted as having any dependency or requirement relating to any one or combination of components shown in illustrative computing system environment 700.

Computing system environment 700 may include content distribution computing device 701 having processor 703 for controlling overall operation of content distribution computing device 701 and its associated components, including random-access memory (RAM) 705, read-only memory (ROM) 707, communications module 709, and memory 715. Content distribution computing device 101 may include a variety of computer readable media. Computer readable media may be any available media that may be accessed by content distribution computing device 701, may be non-transitory, and may include volatile and nonvolatile, removable and non-removable media implemented in any method or technology for storage of information such as computer-readable instructions, object code, data structures, program modules, or other data. Examples of computer readable media may include random access memory (RAM), read only memory (ROM), electronically erasable programmable read only memory (EEPROM), flash memory or other memory technology, compact disk read-only memory (CD-ROM), digital versatile disks (DVD) or other optical disk storage, magnetic cassettes, magnetic tape, magnetic disk storage or other magnetic storage devices, or any other medium that can be used to store the desired information and that can be accessed by computing device 701.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor on content distribution computing device 701. Such a processor may execute computer-executable instructions stored on a computer-readable medium.

Software may be stored within memory 715 and/or storage to provide instructions to processor 703 for enabling content distribution computing device 701 to perform various functions. For example, memory 715 may store software used by content distribution computing device 701, such as operating system 717, application programs 719, and associated database 721. Also, some or all of the computer executable instructions for content distribution computing device 701 may be embodied in hardware or firmware. Although not shown, RAM 705 may include one or more applications representing the application data stored in RAM 705 while content distribution computing device 701 is on and corresponding software applications (e.g., software tasks) are running on content distribution computing device 701.

Communications module 709 may include a microphone, keypad, touch screen, and/or stylus through which a user of content distribution computing device 701 may provide input, and may also include one or more of a speaker for providing audio output and a video display device for providing textual, audiovisual and/or graphical output. Computing system environment 700 may also include optical scanners (not shown). Exemplary usages include scanning and converting paper documents, e.g., correspondence, receipts, and the like, to digital files.

Content distribution computing device 701 may operate in a networked environment supporting connections to one or more remote computing devices, such as computing devices 741, 751, and 761. Computing devices 741, 751, and 761 may be personal computing devices or servers that include any or all of the elements described above relative to content distribution computing device 701. Computing device 761 may be a mobile device (e.g., smart phone) communicating over wireless carrier channel 771.

The network connections depicted in FIG. 7 may include local area network (LAN) 725 and wide area network (WAN) 729, as well as other networks. When used in a LAN networking environment, content distribution computing device 701 may be connected to LAN 725 through a network interface or adapter in communications module 709. When used in a WAN networking environment, content distribution computing device 701 may include a modem in communications module 709 or other means for establishing communications over WAN 729, such as Internet 731 or other type of computer network. The network connections shown are illustrative and other means of establishing a communications link between the computing devices may be used. Various well-known protocols such as transmission control protocol/Internet protocol (TCP/IP), Ethernet, file transfer protocol (FTP), hypertext transfer protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like and are configured to perform the functions described herein.

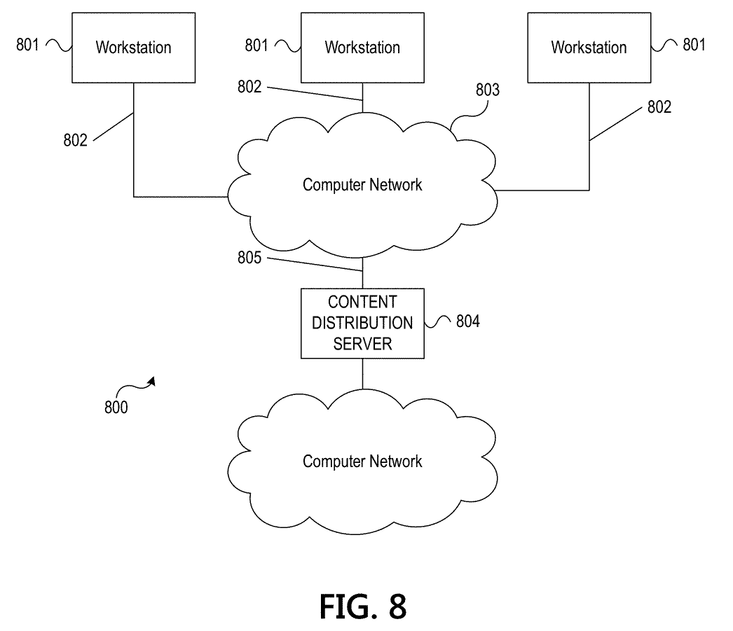

FIG. 8 depicts an illustrative block diagram of workstations and servers that may be used to implement the processes and functions of certain aspects of the present disclosure in accordance with one or more example embodiments. Referring to FIG. 8, illustrative system 800 may be used for implementing example embodiments according to the present disclosure. As illustrated, system 800 may include one or more workstation computers 801. Workstation 801 may be, for example, a desktop computer, a smartphone, a wireless device, a tablet computer, a laptop computer, and the like. Workstations 801 may be local or remote, and may be connected by one of communications links 802 to computer network 803 that is linked via communications link 805 to content distribution server 804. In system 800, content distribution server 804 may be any suitable server, processor, computer, or data processing device, or combination of the same. Server 804 may be used to process the instructions received from, and the transactions entered into by, one or more participants.

Computer network 803 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 802 and 805 may be any communications links suitable for communicating between workstations 801 and content distribution server 804, such as network links, dial-up links, wireless links, hard-wired links, as well as network types developed in the future, and the like.

The system described herein may generally include a user interface configured to receive content for distribution and initiate evaluation of the user and content to determine whether distribution of the content to desired computing destinations is authorized. These arrangements provide an efficient way to control distribution of content at a granular level in a network share. For instance, access to distribute content may be controlled across a level of a file structure and/or at a folder level, as well as at a user level, group or business unit level, role level, and the like. Further, permissions and access may be modified via the user interface such that changes to access to the content distribution system may be efficiently implemented, thereby possibly reducing or eliminating damage that may be cause by distributing malicious content (e.g., content having a virus, or the like).

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may comprise one or more non-transitory computer-readable media.

As described herein, the various methods and acts may be operative across one or more computing servers or platforms and one or more networks. The functionality may be distributed in any manner, or may be located in a single computing device (e.g., a server, a client computer, and the like), or across multiple computing devices. In such arrangements, any and/or all of the above-discussed communications between modules of the computing platform may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A content distribution computing platform, comprising:
a processor;
a communication interface communicatively coupled to the at least a first processor; and
a memory storing computer-readable instructions that, when executed by the at least one processor, cause the content distribution computing platform to:
receive, from a user, content for distribution to a plurality of computing destinations;
determine whether the user is authorized to distribute content to the plurality of computing destinations;
responsive to determining that the user is not authorized, notify the user of a lack of authorization to distribute the content;
responsive to determining that the user is authorized, determine whether a type of content is permitted for distribution to the plurality of computing destinations;
responsive to determining that the type of content is not permitted, transmit a notification to the user that the type of content is not permitted for distribution to the plurality of computing destinations;
responsive to determining that the type of content is permitted, determine whether attributes of the content are permitted for distribution to the plurality of computing destinations;
responsive to determining that the attributes of the content are not permitted for distribution to the plurality of computing destinations, transmit a notification to the user that the attributes are not permitted for distribution to the computing destinations; and
responsive to determining that the attributes of the content are permitted for distribution to the plurality of computing destinations, distribute the content to the plurality of computing destinations.

2. The system of claim 1, wherein the content includes at least one file having a type of file and at least one file attribute.

3. The system of claim 1, wherein the plurality of computing destinations include at least one of: a plurality of folders within a file structure and a plurality of servers.

4. The system of claim 1, wherein the attributes of the content include at least one of: whether the content is read-only, and whether the content is editable.

5. The system of claim 1, wherein determining whether the type of content is permitted for distribution is based on the plurality of computing destinations.

6. The system of claim 5, wherein determining whether the type of content is permitted for distribution is based on a level of the plurality of computing destinations within a file structure.

7. The system of claim 1, wherein determining whether the type of content is permitted for distribution is based on a predetermined role of the user.

8. A method, comprising:
receiving, from a user, content for distribution to a plurality of computing destinations;
determining whether the user is authorized to distribute content to the plurality of computing destinations;
responsive to determining that the user is not authorized, notifying the user of a lack of authorization to distribute the content;
responsive to determining that the user is authorized, determining whether a type of content is permitted for distribution to the plurality of computing destinations;
responsive to determining that the type of content is not permitted, transmitting a notification to the user that the type of content is not permitted for distribution to the plurality of computing destinations;
responsive to determining that the type of content is permitted, determining whether attributes of the content are permitted for distribution to the plurality of computing destinations;
responsive to determining that the attributes of the content are not permitted for distribution to the plurality of computing destinations, transmitting a notification to the user that the attributes are not permitted for distribution to the computing destinations; and
responsive to determining that the attributes of the content are permitted for distribution to the plurality of computing destinations, distributing the content to the plurality of computing destinations.

9. The method of claim 8, wherein the content includes at least one file having a type of file and at least one file attribute.

10. The method of claim 8, wherein the plurality of computing destinations include at least one of: a plurality of folders within a file structure and a plurality of servers.

11. The method of claim 8, wherein the attributes of the content include at least one of: whether the content is read-only, and whether the content is editable.

12. The method of claim 8, wherein determining whether the type of content is permitted for distribution is based on the plurality of computing destinations.

13. The method of claim 12, wherein determining whether the type of content is permitted for distribution is based on a level of the plurality of computing destinations within a file structure.

14. The method of claim 8, wherein determining whether the type of content is permitted for distribution is based on a predetermined role of the user.

15. One or more non-transitory computer-readable media storing instructions that, when executed by a computer system comprising at least one processor, memory, and a communication interface, cause the computer system to:
receive, from a user, content for distribution to a plurality of computing destinations;
determine whether the user is authorized to distribute content to the plurality of computing destinations;
responsive to determining that the user is not authorized, notify the user of a lack of authorization to distribute the content;
responsive to determining that the user is authorized, determine whether a type of content is permitted for distribution to the plurality of computing destinations;
responsive to determining that the type of content is not permitted, transmit a notification to the user that the type of content is not permitted for distribution to the plurality of computing destinations;
responsive to determining that the type of content is permitted, determine whether attributes of the content are permitted for distribution to the plurality of computing destinations;
responsive to determining that the attributes of the content are not permitted for distribution to the plurality of computing destinations, transmit a notification to the user that the attributes are not permitted for distribution to the computing destinations; and
responsive to determining that the attributes of the content are permitted for distribution to the plurality of computing destinations, distribute the content to the plurality of computing destinations.

16. The one or more non-transitory computer-readable media of claim 15, wherein the content includes at least one file having a type of file and at least one file attribute.

17. The one or more non-transitory computer-readable media of claim 15, wherein the plurality of computing destinations include at least one of: a plurality of folders within a file structure and a plurality of servers.

18. The one or more non-transitory computer-readable media of claim 15, wherein the attributes of the content include at least one of: whether the content is read-only, and whether the content is editable.

19. The one or more non-transitory computer-readable media of claim 15, wherein determining whether the type of content is permitted for distribution is based on the plurality of computing destinations.

20. The one or more non-transitory computer-readable media of claim 15, wherein determining whether the type of content is permitted for distribution is based on a predetermined role of the user.
